(19) United States
(12) Patent Application Publication
(10) Pub. No.: US 2025/0305104 A1
(43) Pub. Date: Oct. 2, 2025

(54) IRON-BASED AMORPHOUS ALLOY, POWDERY/GRANULAR MATERIAL THEREOF, AND COMPACTED POWDER MATERIAL THEREOF

(71) Applicant: SINTOKOGIO, LTD., Nagoya-shi (JP)

(72) Inventors: Takehiko MIZUNO, Nagoya-shi (JP); Yasushi KINO, Nagoya-shi (JP); Shingo HAYASHI, Nagoya-shi (JP); Sota YOKOI, Nagoya-shi (JP)

(21) Appl. No.: 19/018,129

(22) Filed: Jan. 13, 2025

(30) Foreign Application Priority Data
Mar. 29, 2024 (JP) 2024-057454

(51) Int. Cl. C22C 45/02; B22F 1/05

(52) U.S. Cl. CPC C22C 45/02; B22F 1/05; B22F 2304/058; B22F 2304/10

(57) ABSTRACT

To achieve both a high saturation magnetization Ms and a low coercivity Hc in an iron-based amorphous alloy. An iron-based amorphous alloy is an iron-based amorphous alloy represented by a composition formula FeaSibBcPdCe, the composition ratio a satisfying 76.0≤a≤80.0, the composition ratio b satisfying 3.0≤b≤6.9, the composition ratio c satisfying 9.9≤c≤14.0, the composition ratio d satisfying 0.8≤d≤4.6, the composition ratio e satisfying 1.0≤e≤4.1.

This Nonprovisional application claims priority under 35 U.S.C. § 119 on Patent Application No. 2024-057454 filed in Japan on Mar. 29, 2024, the entire contents of which are hereby incorporated by reference.

### TECHNICAL FIELD

The present invention relates to an iron-based amorphous alloy, a powdery/granular material thereof, and a compacted powder material thereof.

### BACKGROUND ART

Powdery/granular material made of a soft magnetic iron-based amorphous alloy has a high processability, and thus is processed into various shapes and sizes, such as ribbon form, wire form, or powdery/granular material, as well as use as bulk material, for wide use. For example, many of the compacted powder materials obtained by molding powdery/granular materials made of the iron-based amorphous alloy by powder compacting exhibit excellent magnetic properties. Therefore, compacted powder material made of the iron-based amorphous alloy can be a potent magnetic material.

Patent Literature 1 discloses an iron-based amorphous alloy consisting of Fe, Si, B, P, C, and M which is a supercooling improvement element, as an iron-based amorphous alloy that can be manufactured at a relatively low cost without using very expensive materials, such as Ga, Pd, and Zr. Here, the supercooling improvement element M is an element having a function of facilitating amorphization of the iron-based amorphous alloy. Patent Literature 1 discloses Nb and Mo as the supercooling improvement element M.

### CITATION LIST

### Patent Literature

[Patent Literature 1]
Japanese Patent Application Publication Tokukai No. 2005-290468

### SUMMARY OF INVENTION

### Technical Problem

In a case where the iron-based amorphous alloy is used as a soft magnetic material, the iron-based amorphous alloy tends to be needed to have a high saturation magnetization Ms (or saturation magnetic flux density Bs) and a low coercivity Hc. In Patent Literature 1, the saturation magnetic flux density Bs is used instead of the saturation magnetization Ms. The saturation magnetization Ms can be converted into the saturation magnetic flux density Bs, and thus the saturation magnetic flux density Bs is used when explaining the iron-based amorphous alloy disclosed in Patent Literature 1.

To obtain a high saturation magnetization Ms, in essence, it is simply necessary to increase an amount of Fe contained in the iron-based amorphous alloy. However, a higher composition ratio of Fe the iron-based amorphous alloy contains, the more likely the crystalline phase is precipitated in addition to the amorphous phase. Manufacturers of iron-based amorphous alloys often design composition ratios of the elements so as to facilitate amorphization of the iron-based amorphous alloys and to inhibit the precipitation of the crystallization phase. That is, the manufacturers often design the composition ratios of the elements so as to successfully achieve both the desired saturation magnetization Ms and coercivity Hc.

Actually referring to Table 3 and Table 4 of Patent Literature 1, a supercooling degree ΔTx and a saturation magnetic flux density Bs are found for each of Examples of the iron-based amorphous alloy. In Patent Literature 1, the coercivity Hc is not discussed, but the supercooling degree ΔTx is used as an alternative index. The supercooling degree ΔTx is used as an index indicating easiness of amorphization of the iron-based amorphous alloy. The supercooling degree ΔTx having a greater value tends to lead to easier amorphization.

Among these Examples, the iron-based amorphous alloy exhibiting the highest saturation magnetic flux density Bs is Example 4-1, and the iron-based amorphous alloy exhibiting the greatest supercooling degree ΔTx is Example 3-6. Examples 4-1 shows a supercooling degree ΔTx of 40.2 and a saturation magnetic flux density Bs of 1.53 T. Example 3-6 shows a supercooling degree ΔTx of 52.8 and a saturation magnetic flux density Bs of 1.13 T.

As such, the iron-based amorphous alloy has a tendency that improvement in one of the saturation magnetization Ms and the coercivity Hc leads to deterioration in the other magnetic property. In other words, it is difficult to achieve both a high saturation magnetization Ms and a low coercivity Hc (or a great supercooling degree ΔTx) in an iron-based amorphous alloy.

An aspect of the present invention has been implemented in light of the foregoing issue, and it is an object thereof to achieve both a high saturation magnetization Ms and a low coercivity Hc in an iron-based amorphous alloy represented by a composition formula FeₐSi_{b}B_{c}P_{d}Cₑ. More specifically, it is an object thereof to provide a powdery/granular material made of an iron-based amorphous alloy having a coercivity Hc satisfying Hc≤300 A/m and having a saturation magnetization Ms satisfying Ms≥155 emu/g.

### Solution to Problem

In order to attain the above object, an iron-based amorphous alloy in accordance with an aspect of the present invention is an iron-based amorphous alloy represented by a composition formula FeₐSi_{b}B_{c}P_{d}Cₑ. In the iron-based amorphous alloy, in a case where respective composition ratios a, b, c, d, and e of the elements Fe, Si, B, P, and C are each expressed as a percentage, a sum of a, b, c, d, and e satisfies 97.0≤a+b+c+d+e≤100, the composition ratio a of Fe satisfies 76.0≤a≤80.0, the composition ratio b of Si satisfies 3.0≤b≤6.9, the composition ratio c of B satisfies 9.9≤c≤14.0, the composition ratio d of P satisfies 0.8≤d≤4.6, and the composition ratio e of C satisfies 1.0≤e≤4.1.

In order to attain the above object, a powdery/granular material in accordance with an aspect of the present invention is made of the above-described iron-based amorphous alloy.

In order to attain the above object, a compacted powder material in accordance with one aspect of the present invention is made of the above-described powdery/granular material.

### Advantageous Effects of Invention

An aspect of the present invention makes it possible to achieve both a high saturation magnetization Ms and a low coercivity Hc in an iron-based amorphous alloy represented by the composition formula FeₐSi_{b}B_{c}P_{d}Cₑ.

### BRIEF DESCRIPTION OF DRAWINGS

FIG. 1 is a graph illustrating a DSC curve of an iron-based amorphous alloy in accordance with an example of the present invention.

(a) of FIG. 2 is a scatter diagram in which the coercivities of iron-based amorphous alloys in accordance with Examples and Comparative Examples of the present invention are plotted in a space having axes of a composition ratio b of Si and a composition ratio c of B.

(b) of FIG. 2 is a scatter diagram in which the coercivities of the iron-based amorphous alloys are plotted in a space having axes of a composition ratio b of Si and a composition ratio d of P.

(c) of FIG. 2 is a scatter diagram in which the coercivities of the iron-based amorphous alloys are plotted in a space having axes of a composition ratio b of Si and a composition ratio e of C.

(d) of FIG. 2 is a scatter diagram in which the coercivities of the iron-based amorphous alloys are plotted in a space having axes of a composition ratio c of B and a composition ratio d of P.

(e) of FIG. 2 is a scatter diagram in which the coercivities of the iron-based amorphous alloys are plotted in a space having axes of a composition ratio c of B and a composition ratio e of C.

(f) of FIG. 2 is a scatter diagram in which the coercivities of the iron-based amorphous alloys are plotted in a space having axes of a composition ratio d of P and a composition ratio e of C.

FIG. 3 is a scatter diagram in which the coercivities of the iron-based amorphous alloys are plotted in a space having axes of a sum of a composition ratio b of Si and a composition ratio c of B and a sum of a composition ratio d of P and a composition ratio e of C.

### DESCRIPTION OF EMBODIMENTS

### Embodiment 1

The following description will discuss an iron-based amorphous alloy in accordance with Embodiment 1 of the present invention. The iron-based amorphous alloy in accordance with the present embodiment is an iron-based amorphous alloy represented by the composition formula FeₐSi_{b}B_{c}P_{d}Cₑ. In the present embodiment, the respective composition ratios a, b, c, d, and e of the elements Fe, Si, B, P, and C are each expressed as a percentage. The sum of a, b, c, d, and e satisfies 97.0≤a+b+c+d+e≤100. That is, the iron-based amorphous alloy in accordance with the present embodiment may contain an impurity element, which refers to an element other than Fe, Si, B, P, and C, provided that the composition ratio of the impurity element is less than 3.0. In the iron-based amorphous alloy in accordance with the present embodiment, the composition ratio a of Fe satisfies 76.0≤a≤80.0, the composition ratio b of Si satisfies 3.0≤Sb≤6.9, the composition ratio c of B satisfies 9.9≤c≤14.0, the composition ratio d of P satisfies 0.8≤ d≤4.6, and the composition ratio e of C satisfies 1.0≤e≤4.1. In the following description, at& is used as a unit of the composition ratio typified by the composition ratios a, b, c, d, and e. In addition, when a composition ratio typified by the composition ratios a, b, c, d, and e is expressed, the second decimal place is rounded and the result up to the first decimal place is used.

Typical examples of the impurity include O (oxygen). The iron-based amorphous alloy in accordance with the present embodiment contains Fe at the greatest composition ratio. It is thus likely to form, on the surface of the iron-based amorphous alloy, an oxide coating generated mainly by oxidation of Fe caused by oxygen contained in the atmosphere. In addition, an impact, on a solid, of its surface becomes more noticeable when the size of the solid decreases. This is because the smaller the size is, the greater a ratio of the surface area relative to the volume becomes. As described later in Embodiment 2, in a case where the iron-based amorphous alloy is in a form of powdery/granular material, which consists of at least one of powdery material and granular material, the composition ratio of 0 may approach 3.0 beyond 1.0. Nevertheless, it is possible to achieve both a high saturation magnetization Ms and a low coercivity Hc in an iron-based amorphous alloy in which the composition ratio of 0 is less than 3.0. Therefore, an impurity element at a composition ratio of less than 3.0 may be contained in the iron-based amorphous alloy. Note, however, that the composition ratio of the impurity element is preferable low, and may be less than 2.0 or may be less than 1.0.

In addition, it is preferable that in the iron-based amorphous alloy in accordance with the present embodiment, the composition ratio b and the composition ratio c satisfy 15.0≤b+c≤18.0, and the composition ratio d and the composition ratio e satisfy 4.0≤d+e≤6.0.

Examples of the composition ratios a, b, c, d, and e include a:b:c:d:e=78.45:4.15:13:0.95:3.45.

The alloy in accordance with the present embodiment contains more B than the alloys in accordance with Examples of Patent Literature 1. That is, a greater value is employed as the composition ratio c. This configuration makes it possible to increase a density of the alloy, thereby leading to improvement of the saturation magnetization Ms. In addition, this achieves an alloy that can achieve both a high saturation magnetization Ms and a low coercivity Hc by adjusting the composition ratios of the elements other than Fe and B (that is, Si, P, and C).

Further, it is preferable that in the iron-based amorphous alloy in accordance with the present embodiment, the coercivity Hc satisfies Hc≤300 A/m and the saturation magnetization Ms satisfies Ms≥155 emu/g. The magnetic properties (in the present embodiment, the coercivity Hc and the saturation magnetization Ms) of the iron-based amorphous alloy can be measured with use of a magnetic measurement device typified by the Vibrating Sample Magnetometer (VSM) and the Superconducting Quantum Interference Device (SQUID) flux meter.

The iron-based amorphous alloy in accordance with the present embodiment may have a configuration in which the iron-based amorphous alloy has a supercooling degree ΔTx which is a difference between a crystallization temperature Tx and a glass transition temperature Tg, the supercooling degree satisfying ΔTx≥100 K, and the iron-based amorphous alloy has a saturation magnetization Ms satisfying Ms≥155 emu/g. Note that the crystallization temperature is also referred to as a recrystallization start temperature. A method for measuring the saturation magnetization Ms is as described above. The supercooling degree ΔTx can be calculated by measuring a differential scanning calory (DSC) of the iron-based amorphous alloy and using the DSC curve resulting from the measurement. For example, it is possible to carry out DSC measurement using a method described in “method of determining the crystallization temperatures of amorphous metals” specified in H 7151-1991 of Japanese Industrial Standards (JIS) to calculate a supercooling degree ΔTx.

According to JIS H 7151-1991, it is preferable to increase the temperature at a heat rate of 10° C./min, and it is preferable that the measurement device is adjusted such that the baseline of the DSC curve is always a straight line that is as parallel to the temperature axis as possible. This adjustment may be baseline adjustment that is automatically carried out by the DSC measurement device.

In addition, JIS H 7151-1991 states that in a case where there exist a plurality of exothermic peaks in the DSC curve, the intersection between a baseline BLx and a tangent line TLx is determined as the crystallization temperature Tx. Here, the baseline BLx is a line extended, to a high temperature side, from the baseline on a low temperature side of the exothermic peak at the lowest temperature among the peaks at which a sufficient amount of heat is found to be released due to crystallization, and the tangent line TLx is a tangent line at a point where the gradient becomes maximum in the curve on the low temperature side of the exothermic peak. Note that JIS H 7151-1991 does not discuss how to determine the glass transition temperature Tg. If the method for determining the crystallization temperature Tx is also applied to the glass transition temperature Tg, it is as follows. That is, in a case where there exist a plurality of endothermic peaks of the DSC curve, the intersection between a baseline BLg and a tangent line TLg can be determined as the glass transition temperature Tg. Here, the baseline BLg is a line extended, to a high temperature side, from the baseline on a low temperature side of the endothermic peak at the highest temperature among the peaks at which a sufficient amount of heat is found to be absorbed due to glass transition, and the tangent line TLg is a tangent line at a point where the gradient becomes maximum in the curve on the low temperature side of the endothermic peak.

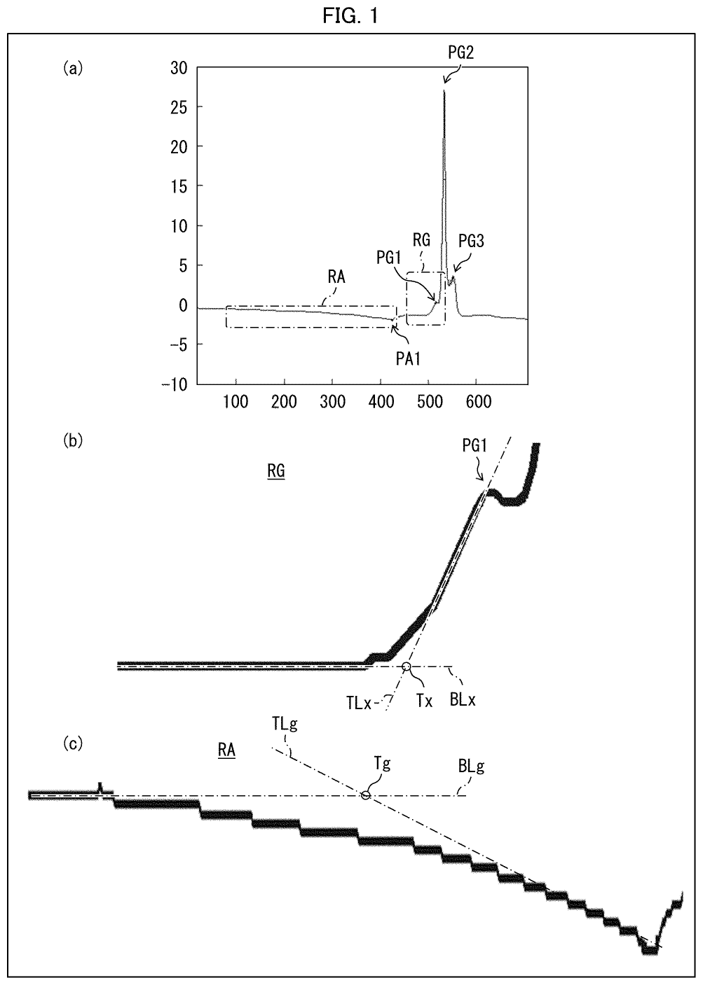

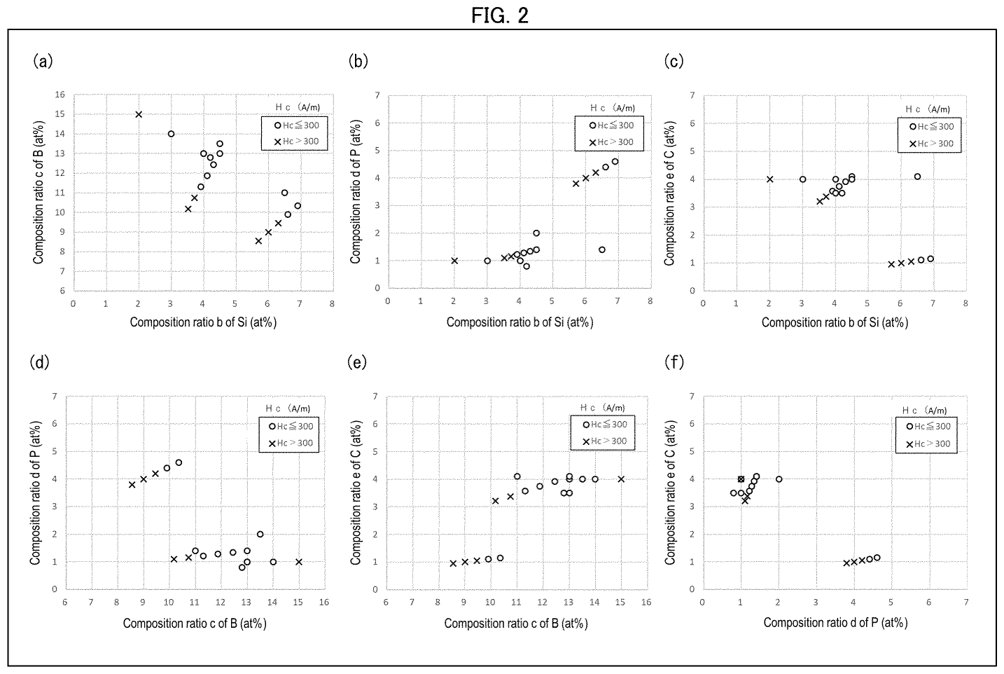

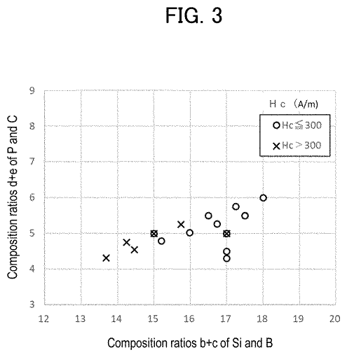

(a) of FIG. 1 is a graph illustrating a DSC curve that was obtained from an example of the iron-based amorphous alloy in accordance with the present embodiment. (b) of FIG. 1, which is an enlarged view of the graph illustrated in (a) of FIG. 1, is an enlarged view illustrating an exothermic area RG in which the iron-based amorphous alloy generates heat in accordance with an increase in the temperature. (b) of FIG. 1 illustrates a baseline BLx and a tangent line TLx. (c) of FIG. 1, which is an enlarged view of the graph illustrated in (a) of FIG. 1, is an enlarged view illustrating an endothermic area RA in which the iron-based amorphous alloy absorbs heat in accordance with an increase in the temperature.

In the DSC curve illustrated in (a) of FIG. 1, there exist three peaks PG1, PG2, and PG3 present in the exothermic area RG and one peak PAI present in the endothermic area RA. The peak PG1 is located at the lowest temperature among the three peaks PG1, PG2, and PG3. Therefore, the intersection between the baseline BLx and the tangent line TLx at the peak PG1 is defined as the crystallization temperature Tx. FIG. 1 indicates that the crystallization temperature TX was approximately 510° C. Similarly, as a result of determining the glass transition temperature Tg by the method as described above, the glass transition temperature Tg was approximately 290° C. Therefore, the supercooling degree ΔTx defined by ΔTx=Tx−Tg is approximately 220° C.

The iron-based amorphous alloy configured as above can be suitably used as raw material of a powdery/granular material described later in Embodiment 2.

Note that a method for manufacturing the iron-based amorphous alloy in accordance with the present embodiment is not particularly limited, and can be selected from existing methods for manufacturing the alloy as appropriate. Therefore, the manufacturing method is not described here.

### Embodiment 2

The following description will discuss a powdery/granular material in accordance with Embodiment 2 of the present invention. The powdery/granular material in accordance with the present embodiment is a powdery/granular material manufactured using the iron-based amorphous alloy in accordance with Embodiment 1 as material. That is, the powdery/granular material in accordance with the present embodiment is made of the alloy described in Embodiment 1.

In the present embodiment, a water atomization process is used as a method for manufacturing a powdery/granular material using the iron-based amorphous alloy in accordance with Embodiment 1 as a material. The water atomization process is a suitable method for manufacturing a powdery/granular material having a relatively small average particle size D50. By the water atomization process, it is possible to manufacture a powdery/granular material having an average particle size D50 of not more than 50 μm. The particle size of the powdery/granular material that can be manufactured by the water atomization process has a lower limit of 0.5 μm at present. Therefore, the powdery/granular material in accordance with the present embodiment has an average particle size D50 successfully satisfying 0.5 μm≤ D50≤50 μm. Further, the powdery/granular material in accordance with the present embodiment has an average particle size D50 successfully satisfying 0.5 μm≤D50≤20 μm. The fact that the average particle size D50 of the powdery/granular material can be reduced enables further reduction in size of the compacted powder material that is described in Embodiment 3 and that is to be used in, for example, electronic components.

Note that the water atomization process is described in, for example, Japanese Patent Application Publication Tokukai No. 2003-034849 and Japanese Patent Application Publication Tokukai No. 2021-055182. Therefore, the water atomization process is not described here.

Further, the method for manufacturing a powdery/granular material in accordance with the present embodiment is not limited to the water atomization process, and may be a manufacturing method, such as the SWAP or the gas atomization process.

### Embodiment 3

A compacted powder material in accordance with Embodiment 3 of the present invention is obtained by molding the powdery/granular material in accordance with Embodiment 2 as a raw material by powder compacting. Therefore, the compacted powder material in accordance with the present embodiment is made of the powdery/granular material in accordance with Embodiment 2. In the compacted powder material in accordance with the present embodiment, the average particle size D50 of the powdery/granular material used as a raw material can be reduced as described above. Therefore, the compacted powder material in accordance with the present embodiment can be reduced in size compared with conventional compacted powder materials.

### Examples

With reference to Table 1 and Table 2, the following description will discuss an Example group consisting of a plurality of Examples of the present invention.

Table 1 lists, for each of the alloys, composition ratios, an iron content, an alloy density, a saturation magnetization Ms, a saturation magnetic flux density Bs, and a coercivity Hc. In Table 1, the numbers of shown decimal places of the composition ratios a to e, the alloy density, the saturation magnetization Ms, and the coercivity Hc are changed depending on the magnitudes of the respective values thereof. Specifically, the composition ratio a and the saturation magnetization Ms are expressed up to the first decimal place, the composition ratios b to e and the alloy density are expressed up to the second decimal place, and the coercivity Hc is expressed as an integer. Note that the composition ratios in Table 1 are composition ratios of the so-called preparation values that are calculated according to a target composition of the iron-based amorphous alloy and composition ratios of elements contained in starting raw material. It is assumed that as described later with reference to Table 2, there is no significant difference between the composition ratios which are preparation values of the elements and the actual composition ratios of the elements in the alloy obtained. Therefore, in Table 1, the composition ratios of the alloy are defined with use of composition ratios which are preparation values of the elements. However, the composition ratios of the alloy may be defined with use of the actual composition ratios of the elements in the alloy obtained.

TABLE 1

| | | | | | | | Alloy | | |
|---|---|---|---|---|---|---|---|---|---|
| | Composition ratio (at %) | | | | | | density | Ms | Hc |
| | Fe | Si | B | P | C | Nb | (g/cm³) | (emu/g) | (A/m) |
| Composition range | 76.0 ≤ a ≤ 80.0 | 3.0 ≤ b ≤ 6.9 | 9.9 ≤ c ≤ 14.0 | 0.8 ≤ d ≤ 4.6 | 1.0 ≤ e ≤ 4.1 | | | | |
| Comparative Example 1 | F 82.0 | T 3.52 | T 10.17 | T 1.10 | T 3.21 | — | 7.38 | 174.7 | 912 |
| Comparative Example 2 | F 81.0 | T 5.70 | F 8.55 | T 3.80 | F 0.95 | — | 7.02 | 168.8 | 696 |
| Comparative Example 3 | F 81.0 | T 3.72 | T 10.74 | T 1.16 | T 3.38 | — | 7.32 | 169.5 | 673 |
| Comparative Example 4 | T 80.0 | T 6.00 | F 9.00 | T 4.00 | T 1.00 | — | 6.95 | 165.3 | 426 |
| Example 1 | T 80.0 | T 3.91 | T 11.30 | T 1.22 | T 3.57 | — | 7.26 | 165.5 | 257 |
| Comparative Example 5 | T 79.0 | T 6.00 | F 9.00 | T 4.00 | T 1.00 | F 1.00 | | 154.1 | 92 |
| Comparative Example 6 | T 79.0 | T 6.30 | F 9.45 | T 4.20 | T 1.05 | — | 6.88 | 163.7 | 354 |
| Example 2 | T 79.0 | T 4.11 | T 11.87 | T 1.28 | T 3.74 | — | 7.21 | 166.4 | 220 |
| Example 3 | T 78.8 | T 4.20 | T 12.80 | T 0.80 | T 3.50 | — | 7.25 | 165.3 | 116 |
| Example 4 | T 78.5 | T 4.00 | T 13.00 | T 1.00 | T 3.50 | — | 7.23 | 163.8 | 88 |
| Example 5 | T 78.0 | T 6.60 | T 9.90 | T 4.40 | T 1.10 | — | 6.82 | 162.0 | 225 |
| Example 6 | T 78.0 | T 4.30 | T 12.44 | T 1.34 | T 3.92 | — | 7.15 | 163.6 | 27 |
| Example 7 | T 78.0 | T 4.00 | T 13.00 | T 1.00 | T 4.00 | — | 7.20 | 165.1 | 10 |
| Example 8 | T 78.0 | T 3.00 | T 14.00 | T 1.00 | T 4.00 | — | 7.24 | 166.0 | 283 |
| Comparative Example 7 | T 78.0 | F 2.00 | F 15.00 | T 1.00 | T 4.00 | — | 7.29 | 166.6 | 597 |
| Example 9 | T 77.0 | T 6.90 | T 10.35 | T 4.60 | T 1.15 | — | 6.75 | 158.0 | 59 |
| Example 10 | T 77.0 | T 4.50 | T 13.00 | T 1.40 | T 4.10 | — | 7.10 | 162.2 | 54 |
| Example 11 | T 77.0 | T 6.50 | T 11.00 | T 1.40 | T 4.10 | — | 7.01 | 160.9 | 24 |
| Example 12 | T 76.0 | T 4.50 | T 13.50 | T 2.00 | T 4.00 | — | 7.01 | 159.1 | 29 |

Table 2 lists actual composition ratios a to e, a saturation magnetization Ms, and a coercivity Hc of each of Examples 13 to 20 of the iron-based amorphous alloys obtained in a case where a:b:c:d:e 78.45:4.15:13:0.95:3.45 is employed as composition ratios of the preparation value. Table 2 indicates that in Examples 13 to 20, the saturation magnetization Ms and the coercivity Hc satisfied Ms≥155 emu/g and Hc≤300 A/m, respectively. Further, Table 2 indicates that a variation in each of the composition ratios a to e fell within a range of ±18. Therefore, it can be assumed that in an iron-based amorphous alloy in accordance with an aspect of the present invention, there is no significant difference between the composition ratios which are preparation values of the elements and the actual composition ratios of the elements in the alloy obtained.

TABLE 2

| VSM data | | Component actual value (at %) | | | | |
|---|---|---|---|---|---|---|
| Ms (emu/g) | Hc (A/m) | Fe | Si | B | P | C |
| Target composition (preparation value) | | 78.5 | 4.15 | 13.00 | 0.95 | 3.45 |
| 164.4 | 50 | 78.5 | 4.24 | 12.90 | 0.98 | 3.42 |
| 163.4 | 73 | 78.5 | 4.06 | 13.03 | 0.93 | 3.45 |
| 164.3 | 67 | 79.1 | 4.10 | 12.40 | 1.05 | 3.32 |
| 165.9 | 147 | 79.0 | 4.17 | 12.20 | 1.09 | 3.55 |
| 164.8 | 60 | 78.2 | 4.03 | 13.40 | 0.95 | 3.44 |
| 164.3 | 46 | 78.1 | 4.25 | 13.15 | 0.97 | 3.52 |
| 164.7 | 39 | 78.5 | 4.11 | 13.06 | 1.02 | 3.33 |
| 165.3 | 74 | 78.3 | 4.16 | 12.93 | 1.03 | 3.60 |

Further, powdery/granular materials made of the iron-based amorphous alloys are produced by the water atomization process using the obtained alloys as materials. Table 1 shows the composition ratios a, b, c, d, and e of the elements with the scope of the present invention shown as each composition range. In addition, for each of the composition ratios a, b, c, d, and e of the alloys, in a case where the symbol T (True) is marked if the composition ratio falls within the composition range, the symbol F (False) is marked if the composition ratio falls outside the composition range. In addition, the alloys that have a, b, c, d, and e, all of which are marked with T are regarded as Examples, and the alloys that have a, b, c, d, and e, at least one of which is marked with F are regarded as Comparative Examples. Note that Table 1 lists the composition ratios a of Fe in decreasing order from the top to the bottom.

It is found that the iron-based amorphous alloys in accordance with Examples each had a supercooling degree ΔTx satisfying ΔTx≥100 K and a saturation magnetization Ms satisfying Ms≥155 emu/g.

FIG. 1 shows a graph illustrating a DSC curve resulting from measurement of an iron-based amorphous alloy in accordance with an example. FIG. 1 indicates that an iron-based amorphous alloy in accordance with an example had a crystallization temperature Tx of approximately 510° C., a glass transition temperature Tg of approximately 290° C., and a supercooling degree ΔTx of approximately 220° C.

(a) of FIG. 2 is a scatter diagram in which the coercivities of iron-based amorphous alloys in accordance with Examples and Comparative Examples of the present invention are plotted in a space having axes of a composition ratio b of Si and a composition ratio c of B. (b) of FIG. 2 is a scatter diagram in which the coercivities of the iron-based amorphous alloys are plotted in a space having axes of a composition ratio b of Si and a composition ratio d of P. (c) of FIG. 2 is a scatter diagram in which the coercivities of the iron-based amorphous alloys are plotted in a space having axes of a composition ratio b of Si and a composition ratio e of C. (d) of FIG. 2 is a scatter diagram in which the coercivities of the iron-based amorphous alloys are plotted in a space having axes of a composition ratio c of B and a composition ratio d of P. (e) of FIG. 2 is a scatter diagram in which the coercivities of the iron-based amorphous alloys are plotted in a space having axes of a composition ratio c of B and a composition ratio e of C. (f) of FIG. 2 is a scatter diagram in which the coercivities of the iron-based amorphous alloys are plotted in a space having axes of a composition ratio d of P and a composition ratio e of C.

FIG. 3 is a scatter diagram in which the coercivities of the iron-based amorphous alloys are plotted in a space having axes of a sum of a composition ratio b of Si and a composition ratio c of B and a sum of a composition ratio d of P and a composition ratio e of C.

In the drawings of FIG. 2 and FIG. 3, an iron-based amorphous alloy having a coercivity Hc satisfying Hc≤300 A/m is plotted as an open circle, and an iron-based amorphous alloy having a coercivity Hc not satisfying Hc≤300 A/m (that is, a coercivity Hc satisfying Hc>300 A/m) is plotted in a cross mark (or x).

The drawings of FIG. 2 are each a correlation diagram obtained by focusing two composition ratios among the composition ratios a to e. Therefore, there exists an iron-based amorphous alloy that is plotted as x even though falling within a composition range in accordance with an aspect of the present invention illustrated in each drawing of FIG. 2 (composition range shown in Table 1). For example, (a) of FIG. 2 indicates that there were five iron-based amorphous alloys that do not satisfy Hc≤300 A/m (that is, there were five Comparative Examples), even among the iron-based amorphous alloys having composition ratios b of Si satisfying 3.0≤b≤6.9. These five Comparative Examples are iron-based amorphous alloys in which at least one of the composition ratios a, c, d, and e, other than the composition ratio b, falls outside the composition range in accordance with an aspect of the present invention.

FIG. 3 indicates that the sum b+c of the composition ratio b of Si and the composition ratio c of B, when satisfying 15.0≤b+c≤18.0, satisfies Hc≤300 A/m. It is also indicated that the sum die of the composition ratio d of P and the composition ratio e of C, when satisfying 4.0≤d+e≤6.0, satisfies Hc≤300 A/m. Some iron-based amorphous alloys even satisfying 15.0≤b+c≤18.0 or some iron-based amorphous alloys even satisfying 4.0≤d+e≤6.0 are plotted as x for the same reason as described above.

Aspects of the present invention can also be expressed as follows:

It is an object of an aspect of the present invention to achieve both a high saturation magnetization Ms and a low coercivity Hc in an iron-based amorphous alloy represented by the composition formula FeₐSi_{b}B_{c}P_{d}Cₑ. More specifically, it is an object thereof to provide a powdery/granular material made of an iron-based amorphous alloy having a coercivity Hc satisfying Hc≤300 A/m and having a saturation magnetization Ms satisfying Ms≥155 emu/g.

In order to attain the above object, an iron-based amorphous alloy in accordance with Aspect 1 of the present invention is an iron-based amorphous alloy represented by a composition formula FeₐSi_{b}B_{c}P_{d}Cₑ. In the iron-based amorphous alloy, in a case where respective composition ratios a, b, c, d, and e of the elements Fe, Si, B, P, and C are each expressed as a percentage, a sum of a, b, c, d, and e satisfies 97.0≤a+b+c+d+e≤100, the composition ratio a of Fe satisfies 76.0≤a≤80.0, the composition ratio b of Si satisfies 3.0≤b≤6.9, the composition ratio c of B satisfies 9.9≤c≤14.0, the composition ratio d of P satisfies 0.8≤d≤4.6, and the composition ratio e of C satisfies 1.0≤e≤4.1.

The iron-based amorphous alloy in accordance with Aspect 1 exhibits a coercivity Hc satisfying Hc≤300 A/m and a saturation magnetization Ms satisfying Ms≥155 emu/g. Therefore, the present iron-based amorphous alloy makes it possible to achieve both a high saturation magnetization Ms and a low coercivity Hc.

In an iron-based amorphous alloy in accordance with Aspect 2 of the present invention, in addition to the configuration of the iron-based amorphous alloy in accordance with Aspect 1 above, a configuration is employed in which the composition ratio b and the composition ratio c satisfy 15.0≤b+c≤18.0, and the composition ratio d and the composition ratio e satisfy 4.0≤d+e≤6.0.

According to the above configuration, it is possible to reliably achieve both a high saturation magnetization Ms and a low coercivity Hc.

In an iron-based amorphous alloy in accordance with Aspect 3 of the present invention, in addition to the configuration of the iron-based amorphous alloy in accordance with Aspect 1 or 2 above, a configuration is employed in which the iron-based amorphous alloy has a coercivity Hc satisfying Hc≤300 A/m and has a saturation magnetization Ms satisfying Ms≥155 emu/g.

The coercivity HC and the saturation magnetization Ms of the magnetic material can be easily measured using a magnetic measurement device typified by, for example, the VSM and the SQUID. This makes it possible to easily confirm whether or not the iron-based amorphous alloy falls within the scope of the present invention.

In an iron-based amorphous alloy in accordance with Aspect 4 of the present invention, in addition to the configuration of the iron-based amorphous alloy in accordance with Aspect 1 or 2 above, a configuration is employed in which the iron-based amorphous alloy has a supercooling degree ΔTx which is a difference between a crystallization temperature Tx and a glass transition temperature Tg, the supercooling degree ΔTx satisfying ΔTx≥100 K; and the iron-based amorphous alloy has a saturation magnetization Ms satisfying Ms≥155 emu/g.

The supercooling degree ΔTx defined by Tx-Tg is used as an index indicating easiness of amorphization. The iron-based amorphous alloy described as Example in Patent Literature 1 exhibits ΔTx=52.8 K at a maximum. The iron-based amorphous alloy in accordance with Aspect 4 satisfies ΔTx≥100 K and thus can be said to be an iron-based amorphous alloy that is significantly more easily made amorphous than conventional ones. Therefore, the present iron-based amorphous alloy makes it possible to achieve both a high saturation magnetization Ms and a low coercivity Hc not only by the SWAP but also by the water atomization process, and thus is suitable as raw material of powdery/granular material.

In order to attain the above object, a powdery/granular material in accordance with Aspect 5 of the present invention is made of the iron-based amorphous alloy in accordance with Aspect 1 or 2 described above.

The powdery/granular material in accordance with Aspect 5 can achieve both a high saturation magnetization Ms and a low coercivity Hc, as in the case of the iron-based amorphous alloy in accordance with Aspect 1.

In a powdery/granular material in accordance with Aspect 6 of the present invention, in addition to the configuration of the powdery/granular material in accordance with Aspect 5 above, a configuration is employed in which the powdery/granular material has an average particle size D50 satisfying 0.5 μm≤D50≤50 μm.

As described above, an iron-based amorphous alloy in accordance with an aspect of the present invention makes it possible to manufacture a powdery/granular material that achieves both a high saturation magnetization Ms and a low coercivity Hc, even by the water atomization process. Therefore, a powdery/granular material made of the iron-based amorphous alloy which has an average particle size D50 satisfying 0.5 μm≤D50≤50 μm can be easily manufactured.

In order to attain the above object, a compacted powder material in accordance with Aspect 7 of the present invention is made of the powdery/granular material in accordance with Aspect 5 or 6 described above.

The compacted powder material in accordance with Aspect 7 makes it possible to achieve both a high saturation magnetization Ms and a low coercivity Hc, as in the case of the powdery/granular materials in accordance with Aspect 5 and Aspect 6.

### [Additional Remark]

The present invention is not limited to the embodiments, but can be altered by a skilled person in the art within the scope of the claims. The present invention also encompasses, in its technical scope, any embodiment derived by combining technical means disclosed in differing embodiments.

1. An iron-based amorphous alloy represented by a composition formula FeₐSi_{b}B_{c}P_{d}Cₑ,
where in a case where respective composition ratios a, b, c, d, and e of the elements Fe, Si, B, P, and C are each expressed as a percentage,
a sum of a, b, c, d, and e satisfies 97.0≤a+b+c+d+e≤100,
the composition ratio a of Fe satisfies 76.0≤a≤80.0,
the composition ratio b of Si satisfies 3.0≤b≤ 6.9,
the composition ratio c of B satisfies 9.9≤c≤14.0,
the composition ratio d of P satisfies 0.8≤d≤4.6, and
the composition ratio e of C satisfies 1.0≤e≤4.1.

2. The iron-based amorphous alloy according to claim 1, wherein:
the composition ratio b and the composition ratio c satisfy 15.0≤b+c≤18.0; and
the composition ratio d and the composition ratio e satisfy 4.0≤d+e≤6.0.

3. The iron-based amorphous alloy according to claim 1, wherein the iron-based amorphous has a coercivity Hc satisfying Hc≤300 A/m and has a saturation magnetization Ms satisfying Ms≥155 emu/g.

4. The iron-based amorphous alloy according to claim 1, wherein:
the iron-based amorphous alloy has a supercooling degree ΔHx which is a difference between a crystallization temperature Tx and a glass transition temperature Tg, the supercooling degree ΔTx satisfying ΔTx≥100 K; and
the iron-based amorphous alloy has a saturation magnetization Ms satisfying Ms≥155 emu/g.

5. A powdery/granular material made of the iron-based amorphous alloy according to claim 1.

6. The powdery/granular material according to claim 5, wherein the powdery/granular material has an average particle size D50 satisfying 0.5 μm≤D50≤50 μm.

7. A compacted powder material made of the powdery/granular material according to claim 5.
